(19) United States
(12) Patent Application Publication
(10) Pub. No.: US 2025/0007414 A1
(43) Pub. Date: Jan. 2, 2025

(54) SWITCHING POWER SUPPLY

(71) Applicant: ROHM CO., LTD., Kyoto (JP)

(72) Inventors: Kosuke SATO, Kyoto (JP); Shinya KARASAWA, Kyoto (JP)

(21) Appl. No.: 18/884,289

(22) Filed: Sep. 13, 2024

Related U.S. Application Data
(63) Continuation of application No. PCT/JP2023/008153, filed on Mar. 3, 2023.

(30) Foreign Application Priority Data
Mar. 17, 2022 (JP) 2022-043070

(51) Int. Cl. H02M 3/335; G04F 10/00; H02M 1/00

(52) U.S. Cl. CPC H02M 3/33573; G04F 10/005; H02M 1/0012; H02M 3/33571; H02M 3/33592

(57) ABSTRACT

A control circuit controls a switching power supply that includes a switching transistor. A first switching detection pin is connected to a first node in the switching power supply, and a second switching detection pin is connected to a second node N in the switching power supply. A time-to-digital converter generates a digital value that represents time difference between a notable edge of a first switching voltage that appears at the first switching detection pin and a notable edge of a second switching voltage that appears at the second switching detection pin. A DSP generates a control pulse that instructs on/off of the switching transistor, with reference to at least the digital value.

### BACKGROUND

### 1. Technical Field

The present disclosure relates to a switching power supply.

### 2. Description of the Related Art

There has been a demand for improving efficiency of switching power supply such as LLC converter, isolated DC (direct current)/DC converter, and non-isolated high-frequency DC/DC converter. Although silicon (Si) MOSFET or bipolar transistor has been used so far as a switching element of the switching power supply, recent attention is focused on high electron mobility transistor (HEMT) with use of gallium nitride (GaN), as an alternative. Owing to its excellent high frequency characteristics, low operation resistance, and high withstand voltage, GaN-HEMT has been expected to achieve high efficiency and downsizing of switching power supply, after replacing the Si device.

GaN HEMT causes, during reverse conduction, voltage drop several times that of Si, which increases loss during a dead time period. In order to operate the GaN device with higher efficiency than the Si device, technologies such as nanosecond-scale dead time control, and delay time correction between the primary and the secondary sides of the transformer will take on greater importance.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a switching power supply according to an embodiment;

FIG. 2 is a circuit diagram illustrating an exemplary structure of a time-to-digital converter;

FIG. 3 is an operation waveform chart of the time-to-digital converter illustrated in FIG. 2;

FIG. 4 is a block diagram of a switching power supply equipped with a control circuit, according to a modified example;

FIG. 5 is a circuit diagram of a switching power supply equipped with a control circuit, according to Example 1;

FIG. 6 is an operation waveform chart of the switching power supply illustrated in FIG. 5;

FIG. 7 is a circuit diagram of a switching power supply equipped with a control circuit, according to Example 2;

FIG. 8 is a circuit diagram of a switching power supply equipped with a control circuit, according to Example 3;

FIG. 9 is an operation waveform chart of the switching power supply illustrated in FIG. 8;

FIG. 10 is a circuit diagram of a switching power supply equipped with a control circuit, according to Example 4;

FIG. 11 is a circuit diagram of a switching power supply equipped with a control circuit, according to Example 5; and

FIGS. 12A to 12F are circuit diagrams each illustrating a topology of a main circuit of a switching power supply.

### DETAILED DESCRIPTION

### Outline of Embodiments

Some exemplary embodiments of the present disclosure will be outlined. This outline is intended for briefing some concepts of one or more embodiments, for the purpose of basic understanding of the embodiments, as an introduction before detailed description that follows, without limiting the scope of the invention or disclosure. This outline is not an extensive overview of all possible embodiments, and is therefore intended neither to specify key elements of all embodiments, nor to delineate the scope of some or all of the embodiments. For convenience, the term “one embodiment” may be used to designate a single embodiment (Example or Modified Example), or a plurality of embodiments (Examples or Modified Examples) disclosed in the present specification.

A control circuit according to an embodiment controls a switching power supply that includes a switching transistor. The control circuit contains a first switching detection pin to be connected to a first node in the switching power supply; a second switching detection pin to be connected to a second node in the switching power supply; a time-to-digital converter structured to generate a digital value that represents a time difference between a notable edge of a first switching voltage that appears at the first switching detection pin and a notable edge of a second switching voltage that appears at the second switching detection pin; and a software-controllable digital signal processor structured to generate a control pulse that instructs on/off of the switching transistor, with reference to at least the digital value.

With the two switching detection pins, and the time-to-digital converter that measures the time difference between the notable edges of two switching voltages that appear at these pins, added to the control circuit equipped with the digital signal processor, this embodiment can detect a response speed of the circuit with a nanosecond-scale resolution. With the time difference that appears between the two signals reflected on the control of the switching power supply, the switching power supply will have improved efficiency. Since the time-to-digital converter is added to the control circuit equipped with the digital signal processor, so that what signal is to be input to the two switching detection pins, and what type of correction is to be employed, may be designed flexibly with use of a software program product.

In one embodiment, the control circuit may further contain a multiplexer arranged in a preceding stage of the time-to-digital converter, and is structured to output, by swapping, a signal at the first switching detection pin and a signal at the second switching detection pin. This makes it possible to measure different time intervals between the two signals.

In one embodiment, the control circuit may further have a third switching detection pin to be connected to a third node in the switching power supply; a fourth switching detection pin to be connected to a fourth node in the switching power supply; and a multiplexer arranged in a preceding stage of the time-to-digital converter, and is structured to output any two of the first switching detection pin, the second switching detection pin, the third switching detection pin, and the fourth switching detection pin, selected with reference to a control signal. This makes it possible to measure time delays between different nodes. In one embodiment, the digital signal processor may be structured to conduct calibration with reference to the digital value.

In one embodiment, the digital signal processor may be structured to reflect the digital value, on a control parameter of a main feedback loop. The control parameter may be, for example, a set value of dead time, or detection timing of electric current or voltage.

In one embodiment, the digital signal processor may be structured to correct a duty cycle of the control pulse, based on the digital value.

In one embodiment, the switching power supply may contain a transformer; a bridge circuit connected to a primary winding of the transformer; and a synchronous rectifier circuit connected to a secondary winding of the transformer. The first switching detection pin may be connected to receive the control pulse supplied to the switching transistor that constitutes the synchronous rectifier circuit, and the second switching detection pin may be connected to receive voltage that appears in the secondary winding of the transformer. This structure enables detection of actual dead time.

In one embodiment, the digital signal processor may be structured to correct set values of dead times of the control pulse supplied to the bridge circuit and of the control pulse supplied to the synchronous rectifier circuit, with reference to the digital value.

In one embodiment, the switching power supply may contain a transformer; a bridge circuit connected to the primary winding of the transformer; and a rectifier circuit connected to the secondary winding of the transformer. The first switching detection pin may receive the control pulse supplied to the switching transistor that constitutes the bridge circuit, and the second switching detection pin may receive voltage that appears in the secondary winding of the transformer. This structure enables measurement of propagation delay.

In one embodiment, the digital signal processor may be structured to correct timing of current detection in the rectifier circuit, with reference to the digital value.

In one embodiment, the switching power supply may contain a gate driver structured to drive the gate of the switching transistor, in response to the control pulse. The first switching detection pin may receive an output signal at the gate driver, and the second switching detection pin may receive an input signal at the gate driver.

The control circuit in one embodiment may include: a switching detection pin to be connected to a node at which voltage fluctuates in response to on/off of the switching transistor in the switching power supply; a time-to-digital converter structured to receive a control pulse that instructs on/off of the switching transistor, and voltage at the switching detection pin, and to generate a digital signal that represents a time difference between the control pulse and the voltage at the switching detection pin; and a digital signal processor structured to generate the control pulse, with reference to at least the digital signal.

### EMBODIMENTS

Preferred embodiments will be explained below, referring to the attached drawings. All similar or equivalent constituents, members and processes illustrated in the individual drawings will be given same reference numerals, so as to properly avoid redundant explanations. The embodiments are merely illustrative, and are not restrictive about the invention. All features and combinations thereof described in the embodiments are not always necessarily essential to the disclosure and invention.

In the present specification, a “state in which a member A is coupled to a member B” includes a case where the member A and the member B are physically and directly coupled, and a case where the member A and the member B are indirectly coupled while placing in between some other member that does not substantially affect the electrically coupled state, or does not degrade the function or effect demonstrated by the coupling thereof.

Similarly, a “state in which member C is provided between member A and member B” includes a case where the member A and the member C, or the member B and the member C are directly connected, and a case where they are indirectly connected, while placing in between some other member that does not substantially affect the electrical connection state among the members, or does not degrade the function or effect demonstrated by the members.

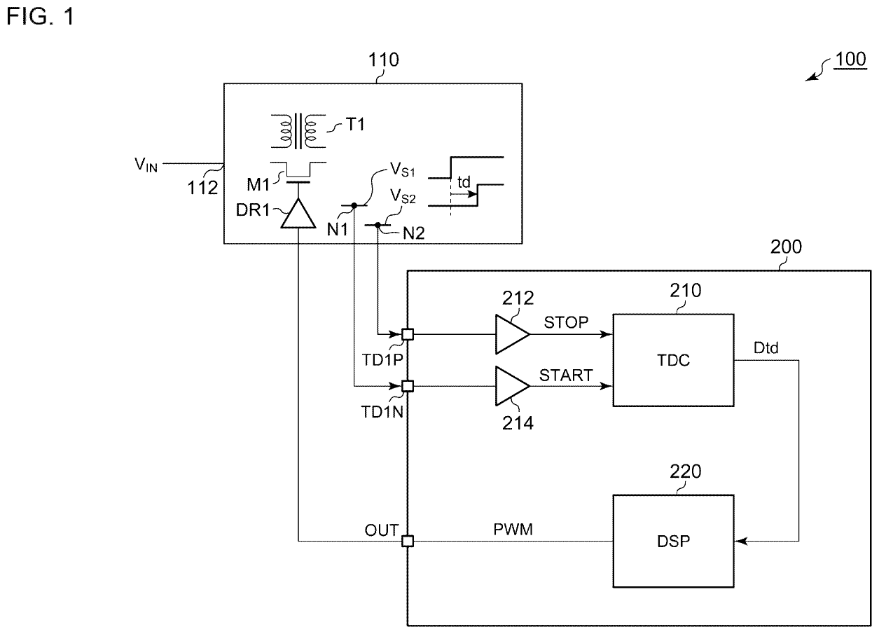

FIG. 1 is a circuit diagram of a switching power supply 100 according to an embodiment. The switching power supply 100 has a main circuit 110, and a control circuit 200. The main circuit 110 contains an inductive element such as transformer T1 or inductor, at least one switching transistor M1, at least one gate driver GD1, and a rectifier circuit. Types of the switching power supply 100 is exemplified by, but not particularly limited to, LLC converter, isolated DC/DC converter, and non-isolated high-frequency DC/DC converter. Circuit topology of the main circuit 110 is designed according to the type of the switching power supply 100. The main circuit 110 has an input node 112 to which DC input voltage VIN is applied, with which a switching transistor M is driven, thus causing output voltage V_{OUT} or output current I_{OUT} supplied to a load connected to an output node 114.

The switching transistor M is a device adaptive to high-speed switching, and is typically GaN-HEMT (GaN-FET). The gate driver GD drives the corresponding switching transistor M, in response to a control pulse PWM.

Note that, also in a case where the main circuit 110 contains a plurality of switching transistors M, such reference sign M is used to collectively denote the plurality of switching transistors, optionally with use of a subscript for distinction. The same applies to the gate driver GD and the control pulse PWM.

The control circuit 200 generates the control pulse PWM that instructs on/off of the switching transistor M contained in the main circuit 110. The control circuit 200 contains a first switching detection pin TD1N, a second switching detection pin TD1P, a time-to-digital converter 210, a first buffer 212, a second buffer 214, and a digital signal processor (DSP) 220.

The first switching detection pin TD1N is connected to a first node N1 in the main circuit 110 of the switching power supply 100. The second switching detection pin TD1P is connected to a second node N2 in the main circuit 110 of the switching power supply 100.

The time-to-digital converter 210 receives first switching voltage Vs1 at the first switching detection pin TD1N and the second switching voltage Vs2 at the second switching detection pin TD1P, and generates a digital value Dtd that represents time difference td between a notable edge of the first switching voltage Vs1 and a notable edge of the second switching voltage Vs2.

In a preceding stage of the time-to-digital converter 210, there are provided the first buffer 212 and the second buffer 214. The first buffer 212 receives the first switching voltage Vs1, and generates a high/low binary start signal START asserted (raised to high, for example) at a notable edge (either positive edge or negative edge) of the first switching voltage Vs1. The second buffer 214 receives the second switching voltage Vs2, and generates a high/low binary stop signal STOP asserted at a notable edge (either positive edge or negative edge) of the second switching voltage Vs2.

The time-to-digital converter 210 measures a delay time td from assertion of the start signal START to assertion of the stop signal STOP.

The DSP 220 may conduct arithmetic processing whose details may be designed by a software program product. The DSP 220 generates the control pulse PWM that instructs on/off of the switching transistor M. The control pulse PWM is supplied to the corresponding gate driver GD in the main circuit 110. The DSP 220 uses at least a digital value Dtd generated by the time-to-digital converter 210, to generate the control pulse PWM.

If the control circuit 200 constitutes a main controller of the switching power supply 100, the DSP 220 will generate the control pulse PWM by feedback control. More specifically, in the switching power supply 100 designed for constant voltage output, the control pulse PWM is generated by the main feedback loop, so as to bring the output voltage V_{OUT} of the main circuit 110 closer to a target voltage. In the switching power supply 100 designed for constant current output, the control pulse PWM is generated by the main feedback loop, so as to bring the output current I_{OUT} of the main circuit 110 closer to a target current value. The feedback control method is also not particularly limited.

When a main controller (not illustrated) of the switching power supply 100 exists separately from the control circuit 200, the DSP 220 may generate the control pulse PWM in response to a command or information from the main controller. Alternatively, the DSP 220 may generate the control pulse PWM, with reference to a state of an internal node of the main circuit 110.

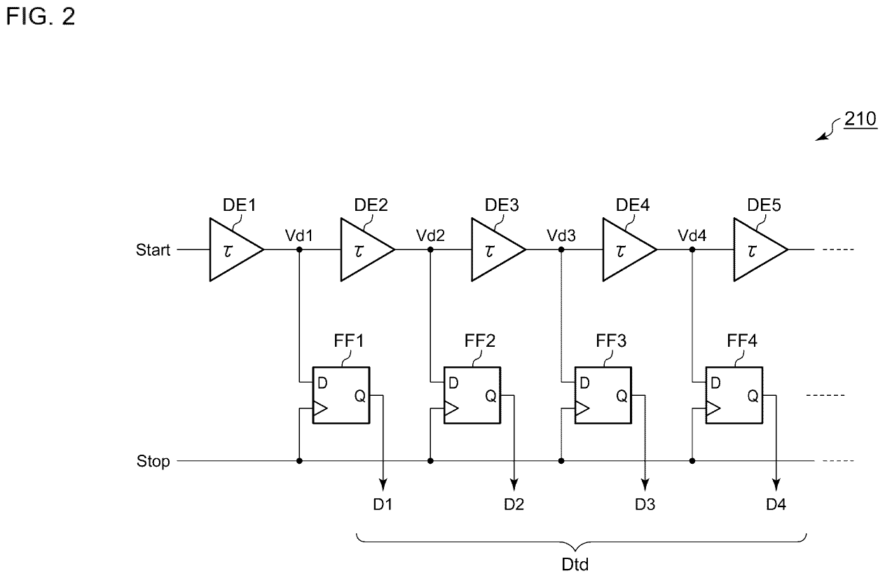

FIG. 2 is a circuit diagram illustrating an exemplary structure of the time-to-digital converter 210. The time-to-digital converter 210 contains a plurality of delay elements DE1, DE2, . . . , DEn, and a plurality of flip-flops FF1, FF2, . . . , FFn.

The plurality of delay elements DE1 to DEn are connected in series. Each of the delay elements DE1 to DEn has an equal delay time t. The delay element DE1 in the first stage will have an input of a first switching voltage Vs1. Each flip-flop FFi (i=1, 2, . . . n) will have input, at an input D, of an output signal Vdi from a corresponded delay element DEi. Each of the plurality of flip-flops FF1 to FFn will have input, at a clock terminal, of a second switching voltage Vs2. Each of outputs D1 to Dn of the plurality of flip-flops FF1 to FFn is a digital value Dtd that represents time difference between a positive edge of the first switching voltage Vs1 and a positive edge of the second switching voltage Vs2. The digital value Dtd is a thermometer code, whose value is given by the number x of bits having a value of 1. Given a value x for the digital value Dtd, the delay time Td of the second switching voltage Vs2 behind the first switching voltage Vs1 will be τ×x. That is, the delay time t of the delay element DE represents time resolution of the time-to-digital converter 210.

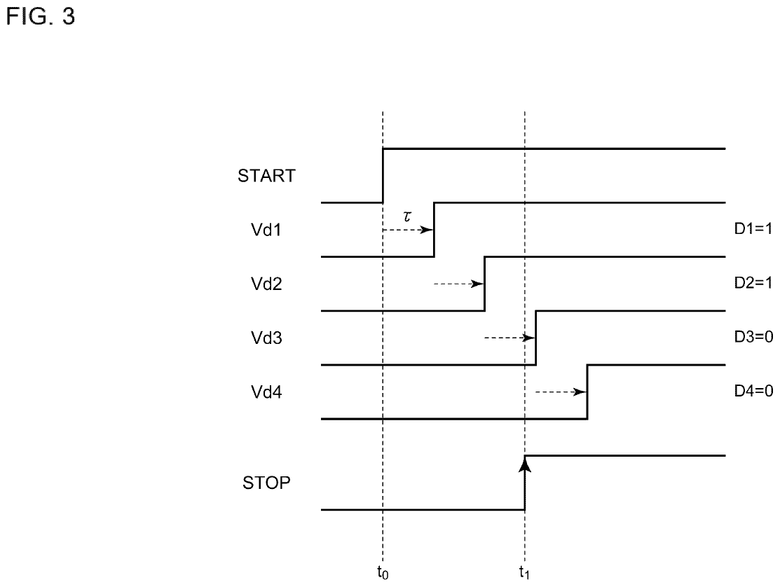

FIG. 3 is an operation waveform chart of the time-to-digital converter 210 illustrated in FIG. 2. The start signal START is asserted (transitioned to high (1)) at time to, and the stop signal STOP is asserted at time t₁. During the period from time t₀ to time t₁, the inputs of the flip-flops FF1 and FF2 sequentially transition to high (1), meanwhile the inputs of the succeeding flip-flops FF3 to FFn are kept low (0). Upon assertion of the stop signal STOP at time t₁, the flip-flops FF1 to FFn latch the individual input signals all at once. As a result, D1 and D2 become 1 (high), and D3 to Dn become 0 (low). Since there are two bits whose thermometer code has a value of 1, the delay time Td is then given by τ×2.

Note that the structure of the time-to-digital converter 210 is not limited to that illustrated in FIG. 2, to which any of those, which have been already known or expected to be available in the future, are applicable.

The control circuit 200 is thus structured. Next, operations thereof will be explained. The first switching detection pin TD1N and the second switching detection pin TD1P are connected to two nodes N1 and N2 in the main circuit 110. The second node N2 will have voltage change that follows the voltage change at the first node N1, causing a delay time td in between. The delay time td is converted to a digital value Dtd, by the time-to-digital converter 210. The digital value Dtd is supplied to the DSP 220. The DSP 220 refers to the digital value Dtd, for generation of the control pulse PWM.

This is all about operations of the control circuit 200.

With the control circuit 200 equipped with the DSP 220, to which the time-to-digital converter 210, two switching detection pins TD1P and TD1N, and the time-to-digital converter 210 are added, this embodiment is now able to detect the delay time td between the two nodes N1 and N2 in the circuit, that is, the response speed, with a nanosecond-scale resolution. With the time difference td that appears between the two nodes N1 and N2 reflected on the control of the switching power supply 100, this embodiment can also improve the efficiency of the switching power supply 100.

Since the time-to-digital converter 210 is added to the control circuit 200 equipped with the DSP 220, so that what signal is to be input to the two switching detection pins TD1P and TD1N, and what type of correction is to be employed, may be designed flexibly with use of a software program product. In other words, the control circuit 200 illustrated in FIG. 1 is applicable to the control circuits for the switching power supplies based on various topologies, only by designing a software program product, while leaving the hardware unchanged.

A possible alternative to the technology according to the present disclosure relates to a technology (comparative technology), designed to detect any change in the switching voltage that appears in the switching power supply 100, with use of a voltage comparator, and to control a timer circuit (counter), in response to an output signal of the voltage comparator. The comparative technique suffers from limited resolution of time measurement, due to response delay of the voltage comparator. In contrast, the present disclosure with use of the TDC enables the nanosecond-scale time measurement, and can optimize the switching control of the switching power supply 100 in the order of nanosecond.

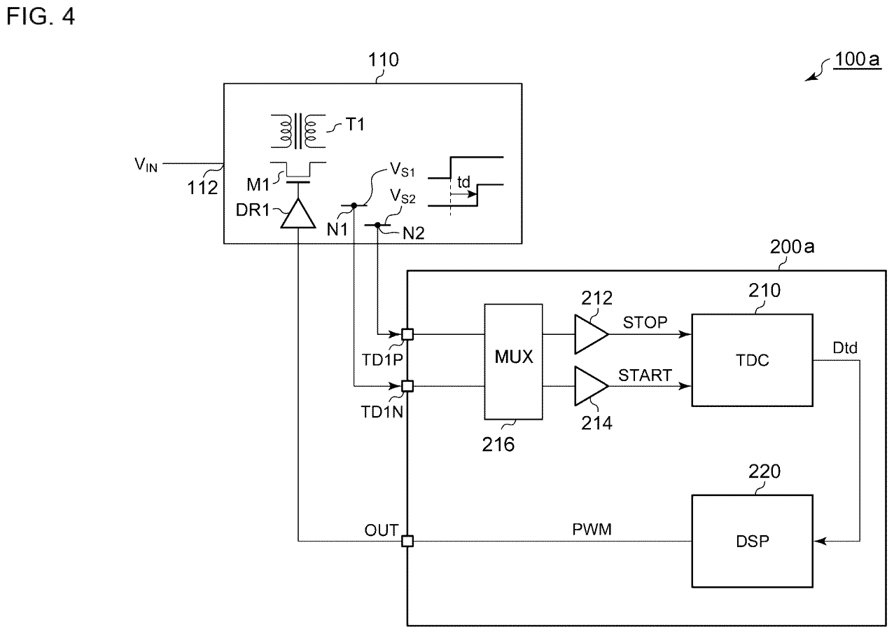

FIG. 4 is a block diagram of a switching power supply 100a equipped with a control circuit 200a, according to a modified example. The control circuit 200a further has a multiplexer 216, in addition to the control circuit 200 illustrated in FIG. 1. The multiplexer 216 can cause switching between a first state φ1 and a second state φ2. The multiplexer 216 outputs, in the first state φ1, a signal at the first switching detection pin TD1P as a stop signal for the time-to-digital converter 210, and a signal at the second switching detection pin TD1N as a start signal for the time-to-digital converter 210. The multiplexer 216 outputs, in the second state φ2, a signal at the first switching detection pin TD1P as a start signal for the time-to-digital converter 210, and a signal at the second switching detection pin TD1N as a stop signal for the time-to-digital converter 210.

Note that the multiplexer 216 may be provided in a subsequent stage of the buffer 212 and the buffer 214.

Addition of the multiplexer 216 can expand a range of combination of measurable edges. For example, even in a situation where sequence of the signal at the first switching detection pin TD1P and the signal at the second switching detection pin TD1N are exchanged, it becomes possible to measure time difference between the two signals. Alternatively, it becomes possible to measure one or both of (i) a time difference between a positive edge of a signal at a certain first switching detection pin TD1P to a positive edge of a signal at the next second switching detection pin TD1N, and (ii) a time difference from a positive edge of a signal at a certain second switching detection pin TD1N to a positive edge of a signal at the next first switching detection pin TD1P.

Paragraphs below will explain some examples of utilization of the digital value Dtd in the DSP 220.

### Use Example 1

The DSP 220 is structured to enable calibration with reference to the digital value Dtd. More specifically, upon activation or during operation of the switching power supply 100, the control circuit 200 is set to a calibration mode. In the calibration mode, the delay time t between the two switching voltages Vs1 and Vs2 is measured by the time-to-digital converter 210. The DSP 220 can correct at least one of lengths (set values) Tf and Tr of the dead time, pulse width (duty cycle) of the control pulse PWM, and slew rate of the control pulse PWM, with reference to the measured delay time td.

The main circuit 110, when containing the transformer T1, may be structured to arrange the first node n1 on the primary side of the transformer T1, and the second node n2 on the secondary side of the transformer T1, thereby allowing a propagation delay from the primary side to the secondary side to be measured. With reference to such propagation delay, correctable is at least one of the set values Tf and Tr of the length of the dead time, the pulse width (duty cycle) of the control pulse PWM, the slew rate of the control pulse PWM, and sampling timing of current detection or voltage detection on the secondary side.

### Use Example 2

During the actual operation of the switching power supply 100, the time-to-digital converter 210 may be kept operated so as to measure the delay time td in real time, thereby allowing at least one of the length of the dead time, the pulse width (duty cycle) of the control pulse PWM, and the slew rate of the control pulse PWM to be feedback controller, with reference to the measured delay time td.

For example, the DSP 220 may generate the control pulse PWM by feedback, so that the digital value Dtd that represents the delay time t approaches a predetermined target value.

For example, the DSP 220 may generate the control pulse PWM by feedback, so that the digital value Dtd that represents the delay time τ approaches a target value according to the operation condition of the switching power supply 100. Operating condition of the switching power supply 100 may include at least one of the input voltage VIN, the output voltage V_{OUT}, and the output current I_{OUT} of the switching power supply 100.

The DSP 220 may alternatively be structured to reflect the digital value Dtd that represents the delay time τ, on a control parameter of a main feedback loop. The control parameter may be a sampling timing of voltage or current, or may be length of the dead time. The control parameter may be any of proportional gain, integral gain, or differential gain of a proportional-integral (PI) controller, or a proportional-integral-differential (PID) controller.

The present disclosure may be understood as the block diagram illustrated in FIG. 1 or as the circuit diagrams, and encompasses various apparatuses and methods derived from the foregoing explanations, without being limited to any specific structure. Hereinafter, more specific exemplary structures and Examples will be described to help understanding or to clarify the spirit or operations of the present disclosure, without narrowing the scope of the present disclosure.

### Example 1

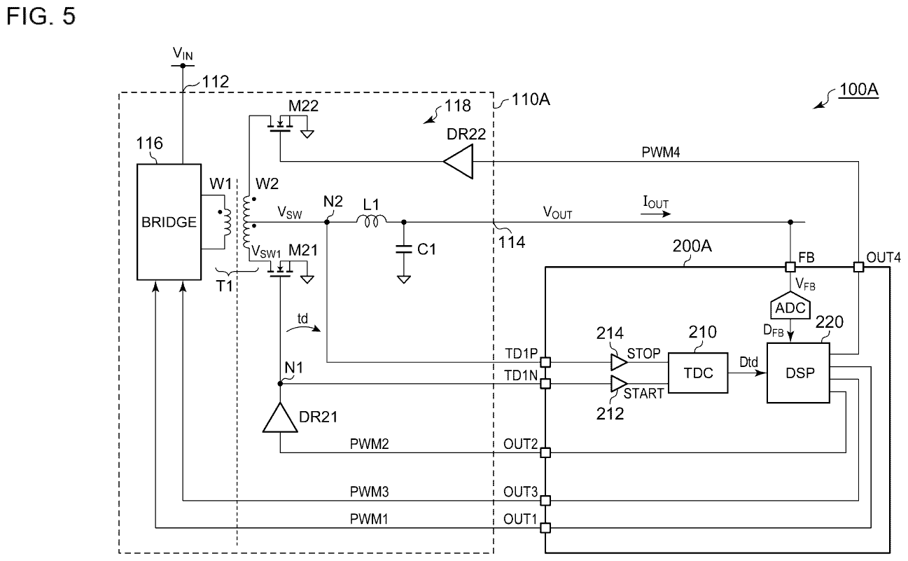

FIG. 5 is a circuit diagram of a switching power supply 100A equipped with a control circuit 200A according to Example 1. A main circuit 110A of the switching power supply 100A has a topology of full-bridge converter or half-bridge converter, and contains a bridge circuit 116 on the primary side, a transformer T1, and a synchronous rectifier circuit 118 on the secondary side.

The bridge circuit 116 on the primary side is connected to a primary winding W1 of the transformer T1. The bridge circuit 116 is a half-bridge circuit or a full-bridge circuit, and contains two, or four switching transistors. The synchronous rectifier circuit 118 contains two switching transistors M21 and M22, an inductor L1, an output capacitor C1, and gate drivers DR21 and DR22, and is connected to a secondary winding W2 of the transformer T1.

The control circuit 200A has a feedback pin FB, to which a feedback signal V_{FB} that corresponds to the output voltage V_{OUT} (or to the output current I_{OUT}) is fed back. An A/D converter 230 converts the feedback signal V_{FB} to a digital signal. A DSP 220 generates control pulses PWM1 to PWM4, so that the digital feedback signal DEB approaches a target value. The control pulses PWM1 and PWM3 are supplied to the bridge circuit 116, meanwhile the control pulses PWM2 and PWM4 are supplied to the switching transistors M21 and M22 in the synchronous rectifier circuit 118. When designed as an isolated converter, the transmission paths of the control pulses PWM1 and PWM3 will have isolators inserted therein.

The first switching detection pin TD1N and the second switching detection pin TD1P of the control circuit 200A are connected to the first node N1 and the second node N2, respectively, in the synchronous rectifier circuit 118. The first node N1 corresponds to the gate of the switching transistor M21 in the synchronous rectifier circuit 118, so that the first switching detection pin TD1N receives a gate signal in response to the control pulse PWM2. The second node N2 is a connection node between the inductor L1 and the secondary winding W2, so that the second switching detection pin TD1P receives the switching voltage Vsw that appears in the secondary winding W2.

The time-to-digital converter 210 measures the time difference td between the gate signal of the switching transistor M21, that is, the notable edge (the negative edge herein) of the control pulse PWM2, and the notable edge (the positive edge herein) of the switching voltage Vsw that appears at the second node N2.

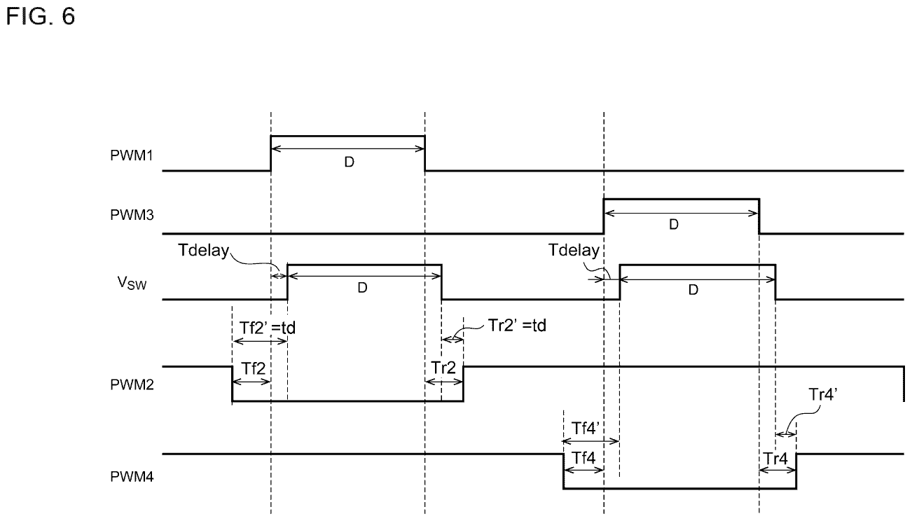

FIG. 6 is an operation waveform chart of the switching power supply 100A illustrated in FIG. 5. The DSP 220 calculates a duty cycle D so that the feedback signal D_{FB} approaches a target value, and generates control pulses PWM1 and PWM3 having a pulse width corresponded to the duty cycle D. The DSP 220 also generates a control pulse PWM2 complementary to the control pulse PWM1. The control pulse PWM2 is generated by adding dead times (set values) Tr2 and Tf2 to the control pulse PWM1. Similarly, the DSP 220 also generates a complementary control pulse PWM4 by adding dead times (set values) Tr4 and Tf4 to the control pulse PWM3.

FIG. 6 illustrates the switching voltage Vsw that appears at the second node N2. There is delay time Tdelay between the transition of the control pulse PWM1, and the transition of the switching voltage Vsw. The delay time Tdelay typically contains propagation delay of the control pulse PWM1 from the secondary side to the primary side, drive delay in the bridge circuit 116, and propagation delay from the primary side to the secondary side of the transformer T1.

In FIG. 6, actual dead times are denoted by Tf2′, Tr2′, Tf4′, and Tr4′. The actual dead time Tf2′ represents a duration from a point when the control pulse PWM2 transitions to low, that is, when the switching transistor M22 turns off, up to a point when the switching voltage Vsw transitions to high. The actual dead time Tf2′ is longer, by the delay time Tdelay, than the design value Tf2 of the dead time.

The actual dead time Tr2′ represents a duration from a point when the switching voltage Vsw transitions to low, up to a point when the control pulse PWM2 transitions to high, that is, when the switching transistor M22 turns on, and is shorter, by the delay time Tdelay, than the design value Tr2 of the dead time.

In the control circuit 200A illustrated in FIG. 5, the time-to-digital converter 210 measures the time difference between the control pulse PWM2 and the switching voltage Vsw, that is, the dead time Tf2′, as the delay time td.

The DSP 220 may alternatively correct the length of the dead time Tf2, so as to optimize the measured delay time td (that is, the actual dead time Tf2′). This successfully shortens the length of dead time to the level of several nanoseconds, thereby improving the efficiency.

The DSP 220 may alternatively calculate the propagation delay Tdelay, from a relation between the known design value Tf2 of the dead time, and the measured actual dead time Tf2′.

$$\\ Tdelay = Tf {2}^{{}_{} ′} - Tf 2$$

In one modified example, the signals input to the first switching detection pin TD1N and the second switching detection pin TD1P may be swapped. That is, the first switching detection pin TD1N may have an input of the switching voltage Vsw, and the second switching detection pin TD1P may have an input of the control pulse PWM2, or the gate signal derived therefrom. The time-to-digital converter 210 measures the time difference td between the notable edge (the negative edge herein) of the switching voltage Vsw that appears at the second node N2, and the notable edge (the positive edge herein) of the gate signal of the switching transistor M21, that is, the control pulse PWM2. This modified example can detect the actual dead time Tr2′ illustrated in FIG. 6, as the time difference td.

The DSP 220 may alternatively calculate the propagation delay Tdelay, from a relation between the known design value Tr2 of the dead time, and the measured actual dead time Tr2′.

$$\\ Tdelay = Tr 2 - Tr {2}^{{}_{} ′}$$

In FIG. 5, the second switching detection pin TD1P may have an input of the voltage Vsw1 at a connection node between the switching transistor M21 and the secondary winding W2, instead of the voltage Vsw at the center tap of the secondary winding W2.

### Example 2

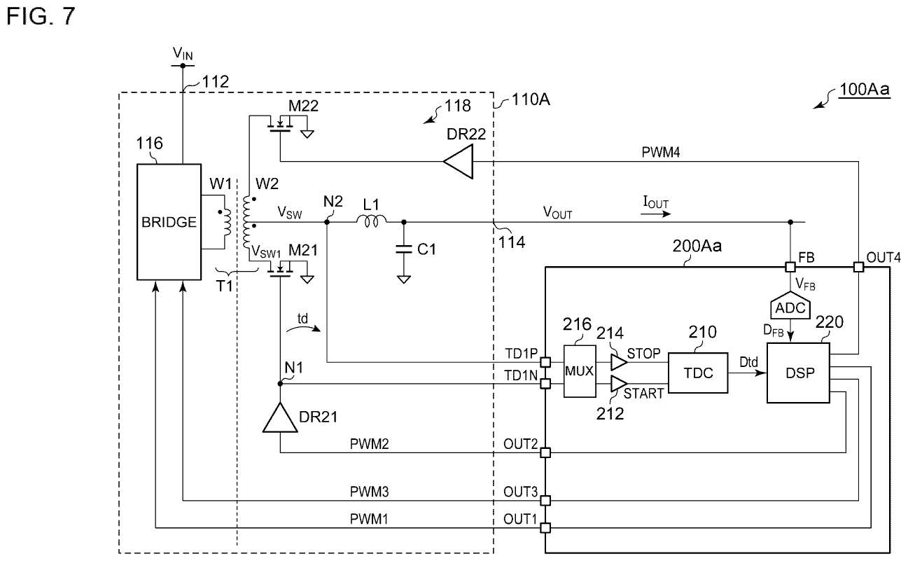

FIG. 7 is a circuit diagram of a switching power supply 100Aa equipped with a control circuit 200Aa, according to Example 2. The control circuit 200Aa is a modification of the control circuit 200A illustrated in FIG. 5, structured on the basis of the control circuit 200a illustrated in FIG. 4, and is equipped with a multiplexer 216.

The multiplexer 216 may be operated while switching the operation state between the first state φ1 and the second state φ2, enabling measurement of dead time Tf2′ in the first state φ1, and measurement of dead time Tr2′ in the second state φ2.

### Example 3

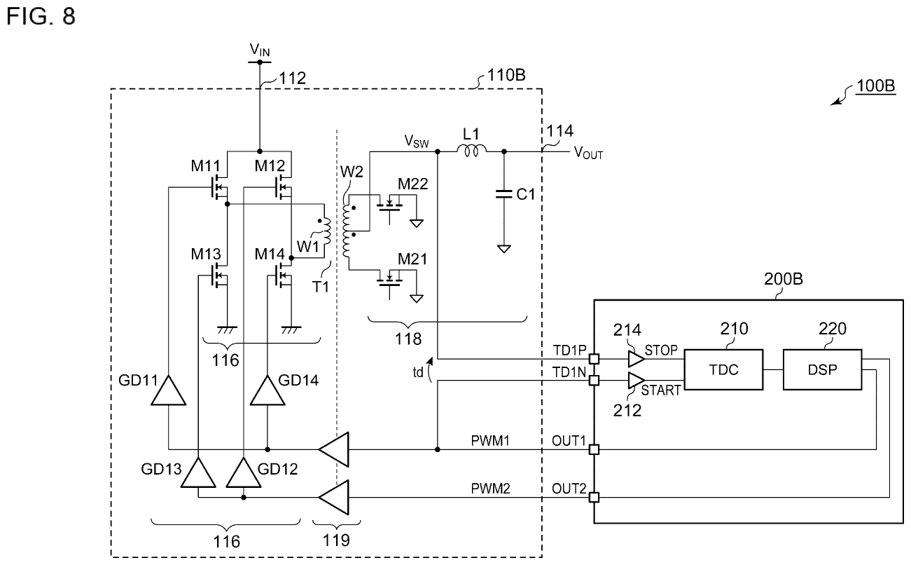

FIG. 8 is a circuit diagram of a switching power supply 100B equipped with a control circuit 200B, according to Example 3. A main circuit 110B of the switching power supply 100B has a topology of full-bridge converter, and contains a full-bridge circuit 116 on the primary side, a transformer T1, and a synchronous rectifier circuit 118 on the secondary side. The bridge circuit 116 contains switching transistors M11 to M14 and gate drivers GD11 to GD14. The switching power supply 100B is an isolated power supply, whose main circuit 110B has an isolator 119 provided therein.

The first switching detection pin TD1N will have an input of the control pulse PWM1. The second switching detection pin TD1P is connected to the secondary winding W2 of the transformer T1, and receives the switching voltage Vsw.

The time-to-digital converter 210 measures the time difference td between the notable edge (positive edge) of the control pulse PWM1, and the notable edge (positive edge) of the switching voltage Vsw.

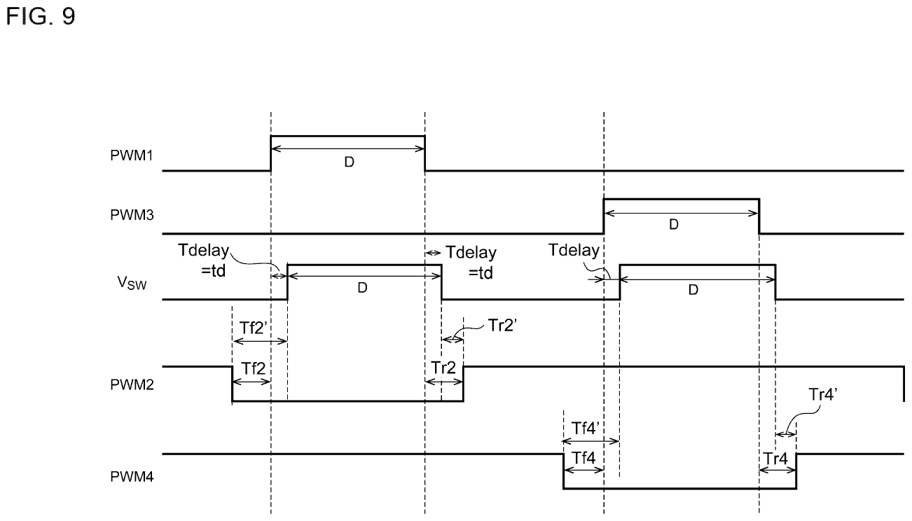

FIG. 9 is an operation waveform chart of the switching power supply 100B illustrated in FIG. 8. There is delay time Tdelay between the transition of the control pulse PWM1, and the transition of the switching voltage Vsw. The delay time Tdelay typically contains propagation delay of the control pulse PWM1 from the secondary side to the primary side in the isolator 119, drive delay in the bridge circuit 116, and propagation delay from the primary side to the secondary side of the transformer T1.

The switching power supply 100B illustrated in FIG. 8 can measure the propagation delay Tdelay. The DSP 220 may alternatively correct the set values Tr2, Tf2, Tr4, and Tf4 of the dead time, with reference to the measured propagation delay Tdelay.

Alternatively, the DSP 220 may optimize the timing of voltage detection or current detection on the secondary side, with reference to the measured delay time Tdelay.

### Example 4

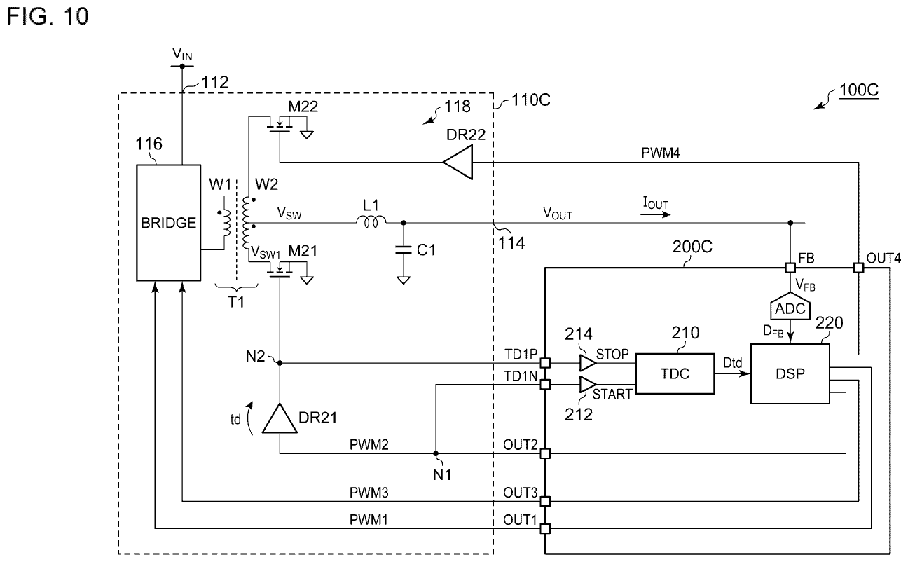

FIG. 10 is a circuit diagram of a switching power supply 100C equipped with a control circuit 200C, according to Example 4. Structure of a main circuit 110C is similar to that of the main circuit 110A illustrated in FIG. 5. The first switching detection pin TD1N of the control circuit 200C is connected to the first node N1 which is an input node of the gate driver DR21. The second switching detection pin TD1P of the control circuit 200C is connected to the second node N2 which is the gate of the switching transistor M21.

The time-to-digital converter 210 detects the time difference td between the input signal and the output signal of the gate driver DR21. The DSP 220 can measure an accurate on-time of the switching transistor M21, with reference to the measured time difference td.

### Example 5

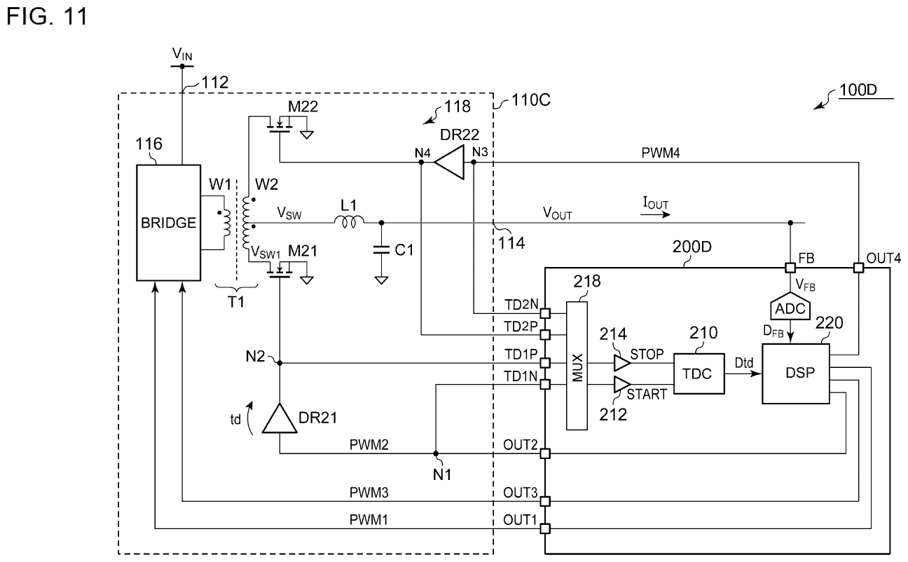

FIG. 11 is a circuit diagram of a switching power supply 100D equipped with a control circuit 200D, according to Example 5. The control circuit 200D is a modification of the control circuit 200 C illustrated in FIG. 10, and further contains two switching detection pins TD2P and TD2N, and a multiplexer 218. The third switching detection pin TD2N is connected to a third node N3 which is an input node of the gate driver DR22. The fourth switching detection pin TD2P is connected to a fourth node N4 which is the gate of the switching transistor M22.

The multiplexer 218 receives signals at the four switching detection pins TD1N, TD1P, TD2N, and TD2P. The multiplexer 218, in its first state, outputs signals at the switching pins TD1N and TD1P, and in its second state, outputs signals at the switching pins TD2N and TD2P. Hence, the control circuit 200D can measure, in the first state, the delay time of the driver DR21, similarly to the control circuit 200C illustrated in FIG. 10, and can measure, in the second state, the delay time of the other driver DR22. This case enables correction of the dead time, independently for each of the two drivers DR21 and DR22.

Note that the aforementioned embodiments are merely illustrative. A skilled person in the art will understand that combinations of the individual constituents or processes may be modified in various ways. Such modified examples will be explained below.

### Modified Example 1

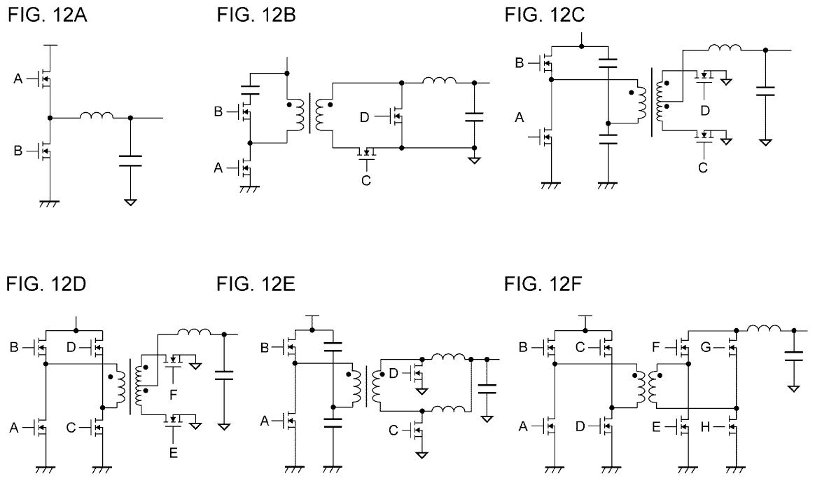

FIGS. 12A to 12F are circuit diagrams each illustrating a topology of a main circuit of a switching power supply 100. FIG. 12A illustrates a step-down (buck) converter. FIG. 12B illustrates a forward converter. FIG. 12C illustrates the half-bridge converter already explained. FIG. 12D illustrates the full-bridge bridge converter already explained. FIG. 12E illustrates a current doubler synchronous rectifier. FIG. 12F illustrates a secondary side full-bridge synchronous rectifier.

### Modified Example 2

The gate driver GD, although arranged outside the control circuit 200 in the embodiment, may alternatively be integrated with the control circuit 200.

### Modified Example 3

Although two switching detection pins were provided in the embodiment, only one switching detection pin may be used alternatively. In a design in which the time-to-digital converter 210 is structured to measure the time difference td between the control pulse and the switching voltage that appears at the switching detection pin, the control pulse may be directly given to the time-to-digital converter 210 inside the control circuit 200.

The embodiments merely illustrate an aspect of the principle and applications of the present disclosure, allowing a variety of modifications and layout changes without departing from the spirit of the present disclosure specified by the claims.

### Supplement

In one aspect, the technology disclosed in the present specification may be understood as follows.

### Item 1

A control circuit for a switching power supply that contains a switching transistor, the control circuit including:

a first switching detection pin to be connected to a first node in the switching power supply;

a second switching detection pin to be connected to a second node in the switching power supply;

a time-to-digital converter structured to generate a digital value that represents a time difference between a notable edge of a first switching voltage appeared at the first switching detection pin and a notable edge of a second switching voltage appeared at the second switching detection pin; and

a software-controllable digital signal processor structured to generate a control pulse that instructs on/off of the switching transistor, with reference to at least the digital value.

### Item 2

The control circuit according to item 1, further including a multiplexer arranged in a preceding stage of the time-to-digital converter, the multiplexer being structured to output, by swapping, a signal at the first switching detection pin and a signal at the second switching detection pin.

### Item 3

The control circuit according to item 1, further including:

a third switching detection pin to be connected to a third node in the switching power supply;

a fourth switching detection pin to be connected to a fourth node in the switching power supply; and

a multiplexer arranged in a preceding stage of the time-to-digital converter, the multiplexer being structured to output any two of the first switching detection pin, the second switching detection pin, the third switching detection pin, and the fourth switching detection pin, selected in response to a control signal.

### Item 4

The control circuit according to any one of items 1 to 3, wherein the digital signal processor is structured to conduct calibration with reference to the digital value.

### Item 5

The control circuit according to any one of items 1 to 3, wherein the digital signal processor is structured to reflect the digital value, on a control parameter of a main feedback loop.

### Item 6

The control circuit according to any one of items 1 to 3, wherein the digital signal processor is structured to correct a duty cycle of the control pulse, based on the digital value.

### Item 7

The control circuit according to any one of items 1 to 6, wherein the switching power supply includes:

a transformer;

a bridge circuit connected to a primary winding of the transformer; and

a synchronous rectifier circuit connected to a secondary winding of the transformer;

the first switching detection pin is connected to receive the control pulse supplied to a switching transistor that constitutes the synchronous rectifier circuit, and

the second switching detection pin is connected to receive voltage that appears in the secondary winding of the transformer.

### Item 8

The control circuit according to item 7, wherein the digital signal processor is structured to correct set values of dead times of the control pulse supplied to the bridge circuit and of the control pulse supplied to the synchronous rectifier circuit, with reference to the digital value.

### Item 9

The control circuit according to any one of items 1 to 6, wherein the switching power supply includes:

a transformer;

a bridge circuit connected to a primary winding of the transformer; and

a rectifier circuit connected to a secondary winding of the transformer;

the first switching detection pin is connected to receive the control pulse supplied to the switching transistor that constitutes the bridge circuit, and

the second switching detection pin is connected to receive voltage that appears in the secondary winding of the transformer.

### Item 10

The control circuit according to item 9, wherein the digital signal processor is structured to correct timing of electric current detection in the rectifier circuit, with reference to the digital value.

### Item 11

The control circuit according to any one of items 1 to 6, wherein the switching power supply has a gate driver structured to drive a gate of the switching transistor, in response to the control pulse,

the first switching detection pin is structured to receive an output signal of the gate driver, and

the second switching detection pin is structured to receive an input signal of the gate driver.

### Item 12

A control circuit for a switching power supply that contains a switching transistor, the control circuit including:

a switching detection pin to be connected to a node at which voltage fluctuates in response to on/off of the switching transistor in the switching power supply;

a time-to-digital converter structured to receive a control pulse that instructs on/off of the switching transistor, and voltage at the switching detection pin, and to generate a digital signal that represents a time difference between the control pulse and the voltage at the switching detection pin; and

a digital signal processor structured to generate the control pulse, in response to at least the digital signal.

### Item 13

A switching power supply that includes the control circuit according to any one of items 1 to 12.

### Item 14

A method for controlling a switching power supply that contains a switching transistor, the method including:

monitoring a switching voltage at a node at which voltage fluctuates in response to on/off of the switching transistor in the switching power supply;

converting, into a digital value, a time difference between a control pulse that instructs the on/off of the switching transistor, and the switching voltage; and

generating the control pulse, with reference to at least the digital value.

What is claimed is:

1. A control circuit for a switching power supply that contains a switching transistor, the control circuit comprising:
a first switching detection pin to be connected to a first node in the switching power supply;
a second switching detection pin to be connected to a second node in the switching power supply;
a time-to-digital converter structured to generate a digital value that represents a time difference between a notable edge of a first switching voltage that appears at the first switching detection pin and a notable edge of a second switching voltage that appears at the second switching detection pin; and
a software-controllable digital signal processor structured to generate a control pulse that instructs on/off of the switching transistor, with reference to at least the digital value.

2. The control circuit according to claim 1, further comprising a multiplexer arranged in a preceding stage of the time-to-digital converter, the multiplexer being structured to output, by swapping, a signal at the first switching detection pin and a signal at the second switching detection pin.

3. The control circuit according to claim 1, further comprising:
a third switching detection pin to be connected to a third node in the switching power supply;
a fourth switching detection pin to be connected to a fourth node in the switching power supply; and
a multiplexer arranged in a preceding stage of the time-to-digital converter, the multiplexer being structured to output any two of the first switching detection pin, the second switching detection pin, the third switching detection pin, and the fourth switching detection pin, selected in response to a control signal.

4. The control circuit according to claim 1, wherein the digital signal processor is structured to conduct calibration with reference to the digital value.

5. The control circuit according to claim 1, wherein the digital signal processor is structured to reflect the digital value, on a control parameter of a main feedback loop.

6. The control circuit according to claim 1, wherein the digital signal processor is structured to correct a duty cycle of the control pulse, based on the digital value.

7. The control circuit according to claim 1, wherein the switching power supply comprises:
a transformer;
a bridge circuit connected to a primary winding of the transformer; and
a synchronous rectifier circuit connected to a secondary winding of the transformer;
the first switching detection pin is connected to receive the control pulse supplied to a switching transistor that constitutes the synchronous rectifier circuit, and
the second switching detection pin is connected to receive voltage that appears in the secondary winding of the transformer.

8. The control circuit according to claim 7, wherein the digital signal processor is structured to correct set values of dead times of the control pulse supplied to the bridge circuit and of the control pulse supplied to the synchronous rectifier circuit, with reference to the digital value.

9. The control circuit according to claim 1, wherein the switching power supply includes:
a transformer;
a bridge circuit connected to a primary winding of the transformer; and
a rectifier circuit connected to a secondary winding of the transformer;
the first switching detection pin is connected to receive the control pulse supplied to the switching transistor that constitutes the bridge circuit, and
the second switching detection pin is connected to receive voltage that appears in the secondary winding of the transformer.

10. The control circuit according to claim 9, wherein the digital signal processor is structured to correct timing of electric current detection in the rectifier circuit, with reference to the digital value.

11. The control circuit according to claim 1, wherein the switching power supply has a gate driver structured to drive a gate of the switching transistor, in response to the control pulse,
the first switching detection pin is structured to receive an output signal of the gate driver, and
the second switching detection pin is structured to receive an input signal of the gate driver.

12. A control circuit for a switching power supply that contains a switching transistor, the control circuit comprising:
a switching detection pin to be connected to a node at which voltage fluctuates in response to on/off of the switching transistor in the switching power supply;
a time-to-digital converter structured to receive a control pulse that instructs on/off of the switching transistor, and voltage at the switching detection pin, and to generate a digital signal that represents a time difference between the control pulse and the voltage at the switching detection pin; and
a digital signal processor structured to generate the control pulse, in response to at least the digital signal.

13. A switching power supply comprising the control circuit according to claim 1.

14. A switching power supply comprising the control circuit according to claim 12.

15. A method for controlling a switching power supply that contains a switching transistor, the method comprising:
monitoring a switching voltage at a node at which voltage fluctuates in response to on/off of the switching transistor in the switching power supply;
converting, into a digital value, a time difference between a control pulse that instructs the on/off of the switching transistor, and the switching voltage; and
generating the control pulse, with reference to at least the digital value.
